(19) United States
(12) Patent Application Publication
(10) Pub. No.: US 2015/0256597 A1
(43) Pub. Date: Sep. 10, 2015

(54) System and Method for Property Data Collection and Management

(71) Applicant: Home Controls, LLC, Dallas, TX (US)

(72) Inventor: Matthew William Gessner, San Antonio, TX (US)

(21) Appl. No.: 14/633,332

(22) Filed: Feb. 27, 2015

Related U.S. Application Data
(60) Provisional application No. 61/947,604, filed on Mar. 4, 2014.

(51) Int. Cl. H04L 29/08

(52) U.S. Cl. CPC H04L 67/06; H04L 67/12

(57) ABSTRACT

Embodiments of the present disclosure provide systems and methods for property data collection and management. Embodiments further disclose systems and methods for gathering information regarding property features, analyzing property feature information and managing the maintenance of the property. Systems and methods include creation of a property report stored in memory identifying relevant property features, organizing the property features, identifying maintenance actions and reminders regarding the property features, communicating the reminders to a user and/or instructions to address the property maintenance actions and reminders. Some embodiments, further provide information and/or facilitate communication with vendors to provide goods and/or services associated with property maintenance.

### CROSS-REFERENCE TO RELATED APPLICATION

This application claims the benefit of priority from U.S. Provisional Patent Application No. 61/947,604 filed on Mar. 4, 2014, which is incorporated herein by reference.

### FIELD OF THE DISCLOSURE

The invention relates generally to the field of property management and maintenance. More specifically, some embodiments relate to systems for collecting data regarding a property and managing the property through maintenance of the various components and aspects of the property.

### BACKGROUND

Real estate properties have a multitude of features that may or should be maintained over time. When properties include various structures—such as homes, offices, sheds, buildings, etcetera—the multitude of maintainable features increases. Property owners may not be aware of all the maintainable features of the property and/or may not know when and how to proceed with maintaining various features.

In addition, the various maintainable features may require different forms of maintenance or other care. For example, some maintainable features may be maintained through periodic replacement of consumable parts. Other maintainable features may require periodic monitoring or testing to determine whether or not any maintenance action is necessary.

Some property owners or prospective owners will conduct or have another person conduct an inspection of a property that may prepare reports that identify the features of the property, including one or more of the maintainable features. These reports may also include information regarding the then current status of one or more features of the property. Accordingly, these reports operate to provide a static assessment of the property and the inspected features.

Some inspectors may provide some information regarding maintenance advice for property owners; however, the information is often in the form of generic maintenance information which may or may not be applicable to aspects of the property. Often the maintenance information or recommendations, such as have heater inspected regularly for leaks, which may be applicable to almost any property with a heater. However, such information may include recommendations that may not be applicable, such as pool maintenance information for houses without pools.

### SUMMARY

The present disclosure provides for a system and method for data collection and property management. Specifically, the system included electronic data collection components which may be networked to a remote database. The system can facilitate detailed information regarding numerous property features and associate those features with additional information and maintenance recommendations and/or reminders.

Embodiments of the present disclosure provide for a mobile computing device networked to a remote server, wherein the mobile computing device is operable to collect data regarding property features and status information.

In some embodiments, the remote server may include a database which is operable to store information collected about a specific property and/or maintenance information regarding various property features. The database may include data from the data collection components and/or other sources, such as product suppliers, instructional information suppliers, and other third parties. The database may facilitate associating information about a specific property with related information regarding various property features. One or more component devices may be able to view and/or update information in the server regarding a property.

In some embodiments, one mobile component may communicate directly to another mobile component. The devices may update automatically with other devices associated with the same property.

In some embodiment, an inspector or data collector and the property owner may have apparatuses implementing the system. The inspector may review the property and input the property information, property features, maintenance product lists and other information, and the property owner may receive the information from the inspector's device at one or more points during the process.

Embodiments of the system may include maintenance reminders. Maintenance reminders may be transmitted to a property owner, a vendor, a property management company and/or other person or entity. The reminders may be posted for users of networked devices with access to the remote server.

In some embodiments, one or more vendors may provide information associated with one or more property features to the remote server. The remote server may be operable to facilitate targeted advertising for product vendors, maintenance companies and/or other entities.

Embodiments of the method of the present disclosure include collecting property information through inputting property feature descriptions into a user device. Some embodiments may provide for inputting the property information using a touch screen to create feature specific descriptions. In some embodiments, a picture of the property feature may be created to improve a user's experience in identifying the specific feature on the property. In some embodiments, the property information is collected in conjunction with a property inspection process, and inspector notes specific to the property may be included. Following the data collection process, the inspector notes may be input into the user device.

In some embodiments, the input process is iterative through a selection process associated with a software application. The process may include selecting an area, such as the kitchen, selecting a feature, such as a disposal machine or oven, selecting model and manufacture information of the feature and selecting a status of the feature. In some embodiments, the feature information may be modified by altering any of the selections.

In some embodiments, the process will further create a list of maintenance reminders associated with the various features. In some embodiments, the process will identify consumables used with various features, such as air filters. In some embodiments, the process will provide links to vendors associated with the property features and/or maintenance information associated with the property features.

The property information may be associated with the property owner or selected representative in some embodiments through identifiable information, a log in system, or an electronic recognition system. In some embodiments, the layout may be electronically provided and/or accessible to the wearer. In some embodiments, a user may use controls or options associated with the property maintenance application to receive instructional information, product details, reminders and/or other information associated with the maintenance of the property.

In some embodiments, the system or method will account for historical information in maintaining the property, issuing a list of consumables for purchase or for other reasons. In some embodiments, the system or method may facilitate communication between a product supplier and a property owner.

### A BRIEF DESCRIPTION OF THE DRAWINGS

Embodiments will now be described, by way of example only, with references to the accompanying drawings in which:

FIG. 1 is a drawing of an embodiment of a system of the disclosure;

FIG. 2 is a block diagram depicting another embodiment of a system of the disclosure;

FIG. 3 is a drawing of an embodiment of a device associated with the disclosure showing an illustrative screen;

FIG. 4 a drawing of another embodiment of a device associated with the disclosure showing another illustrative screen;

FIG. 5 is drawing of another embodiment of a device associated with the disclosure showing another illustrative screen;

FIG. 6 is drawing of another embodiment of a device associated with the disclosure showing another illustrative screen;

FIG. 7 is drawing of another embodiment of a device associated with the disclosure showing another illustrative screen;

FIG. 8 is drawing of another embodiment of a device associated with the disclosure showing another illustrative screen;

FIG. 9 is drawing of another embodiment of a device associated with the disclosure showing another illustrative screen;

FIG. 10 is drawing of another embodiment of a device associated with the disclosure showing another illustrative screen;

FIG. 11 is drawing of another embodiment of a device associated with the disclosure showing another illustrative screen;

FIG. 12 is drawing of another embodiment of a device associated with the disclosure showing another illustrative screen;

FIG. 13 is drawing of another embodiment of a device associated with the disclosure showing another illustrative screen;

FIG. 14 is drawing of another embodiment of a device associated with the disclosure showing another illustrative screen; and

FIG. 15 is drawing of another embodiment of a device associated with the disclosure showing another illustrative screen.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

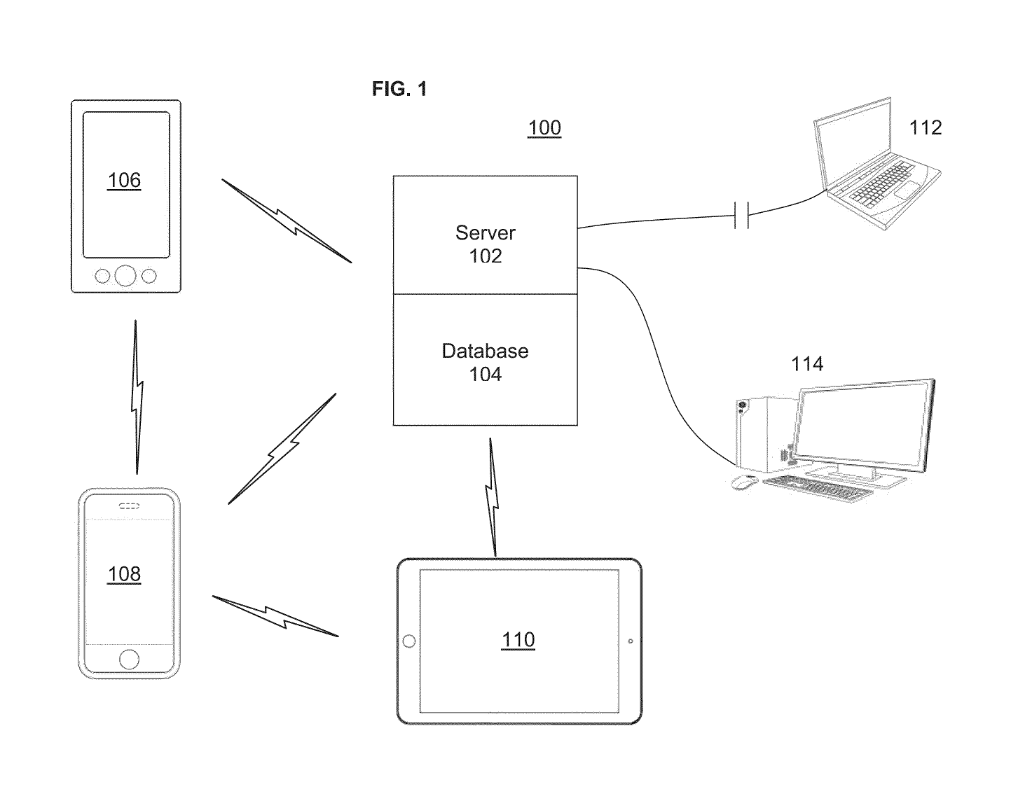

FIG. 1 depicts a system 100 having networked components associated with each other by wireless and wired connections. One skilled in the art will recognize that any means of connecting components to allow communication signals to be transmitted may be implemented and remain within the scope and spirit of the present disclosure. System 100 includes a server 102 which is associated with a database 104. One skilled in the art will recognize that the server 102 may be any computing device capable for the operations described herein and remain within the scope and spirit of the present disclosure. The database 104 may comprise any electronic storage system or component which maintains information in an electronically accessible format and is capable of operation described herein. In some embodiments, system 100 may include multiple servers 102 and/or databases 104. In some embodiments, system 100 may be implemented through a cloud based design.

In some embodiments, the server 102 may be a host server maintained by a third party for access during operation. The server 102 may provide additional analytics or company information associated with the data collection regarding the property and/or maintenance recommendations. For example, the server 102 may facilitate the scheduling of reminders based upon one or more factors relating to the appliances, age and/or wear and tear of components. For another example, an appliance company may allow an property owner access to additional product details and promotions to improve the products associated with the property. The third party may further provide and maintain the application software associated with system 100. One skilled in the art will recognize that the application may be provided as software accessible on a specified location, such as the server 102, downloadable from a storage device, stored in another component of the system 100, issued as a computer program product on a tangible storage medium, and/or otherwise provided or made available for use.

In the system 100, the server 102 is shown as wirelessly connected to a first smart phone 106, a second smart phone 108 and a tablet 110. Collectively the first smart phone 106, the second smart phone 108 and the tablet 110 may be referred to as mobile devices 106, 108 and 110. Each of the mobile devices 106, 108 and 110 shown has a display and a user interface. In some embodiments, the display operates as the user interface utilizing touch screen technology. In some embodiments, one or more of the mobile devices 106, 108 and 110 may also include a camera. In addition to the wireless connection with the server 102, the mobile devices 106, 108 and 110 may be connected wirelessly or via a wire to another one of the mobile devices 106, 108 and 110. For example, the second smart phone 108 is depicted as wirelessly connected to both the first smart phone 106 and the tablet 110. One skilled in the art will recognize that the three mobile devices are depicted to illustrate the variation of devices that may be used in implementing the system disclosed. Unless otherwise noted, the descriptions of mobile devices may be used interchangeably and the descriptions of use are for illustrative purposes only.

In addition to the mobile devices 106, 108 and 110, server 102 is also connected to a remote computer 112 and a local computer 114 through wired connections. In some embodiments, server 102 may be part of the local computer 114 or the remote computer 112.

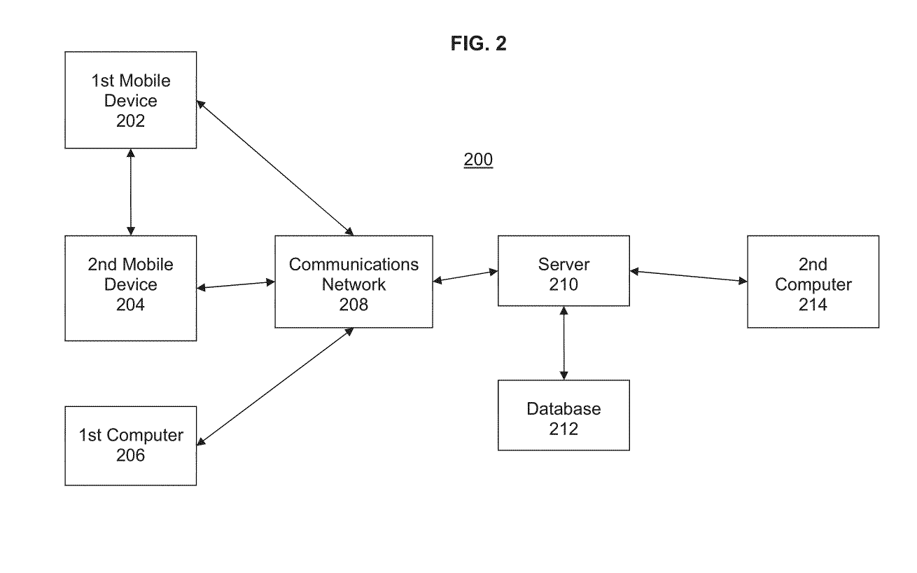

FIG. 2 depicts a system 200 having mobile components including a first mobile device 202, a second mobile device 204 and a first computer 206 networked via a communications network 208 with a server 210. Collectively the first mobile device 202, the second mobile device 204 and the first computer 206 may be referred to as mobile devices 202, 204 and 206. Each of the mobile devices 202, 204 and 206 may include a display, a camera and a user interface. In some embodiments, one or more of mobile devices 202, 204 and 206 may operate as a display only device without a user interface or camera. In some embodiments, the display operates as the user interface utilizing touch screen technology.

The mobile devices 202, 204 and 206 are each shown connected to the communications network 208 which may facilitate communication with the server 210. The mobile devices 202, 204 and 206 may also be connected to another one of the mobile devices 202, 204 and 206. For example, the first mobile device 202 is shown directly connected to the second mobile device 204. Unless otherwise noted, the descriptions of mobile devices may be used interchangeably and the descriptions of use are for illustrative purposes only.

System 200 shows the server 210 connected with a database 212. One skilled in the art will recognize that the server 210 may be any computing device capable for the operations described herein and remain within the scope and spirit of the present disclosure. The database 212 may comprise any electronic storage system or component which maintains information in an electronically accessible format and is capable of operation described herein. In some embodiments, system 200 may include multiple servers 210 and/or databases 212.

In some embodiments, the server 210 may be a host server maintained by a third party for access during operation. The server 210 may provide additional analytics or company information associated with the data collection regarding the property and/or maintenance recommendations. For example, the server 210 may facilitate the scheduling of reminders based upon one or more factors relating to the appliances, age and/or wear and tear of components. For another example, the server 210 may identify promotions of similar products or maintenance components in which a property owner may be interested. The third party may further provide and maintain the application software associated with system 200. One skilled in the art will recognize that the application may be provided as software accessible on a specified location, such as the server 102, downloadable from a storage device, stored in another component of the system 200, issued as a computer program product on a tangible storage medium, and/or otherwise provided or made available for use.

In addition to the mobile devices 202, 204 and 206, server 210 are also connected to a second computer 214. In some embodiments, server 210 may be part of the second computer 214.

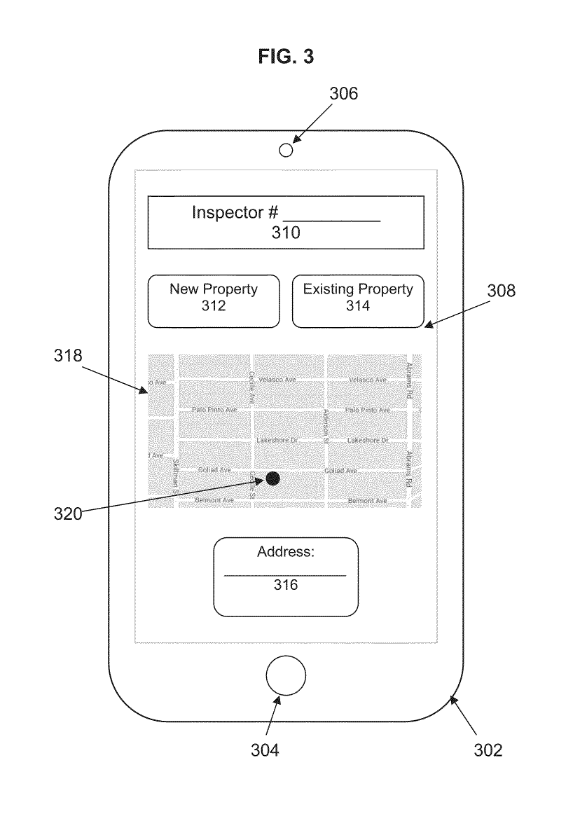

FIG. 3 depicts a tablet 302 operating an embodiment of software for collecting, reviewing and/or updating information regarding a property. For illustrative purposes, the tablet 302 will be discussed primarily as a property inspector's device; however, one skilled in the art will recognize that the tablet 302 may be associated with a company, a vendor, an inspector, a handyman, a property owner and/or another person. One skilled in the art will recognize that the tablet 302 is used as an exemplary device, and the application and operation discussed in the context of tablet 302 may be implemented on alternative components, such as a mobile phone, laptop computer, a computer station, and/or any other devices suitable to perform the operations described. In some embodiments, a combination of devices may be implemented to achieve the desired operational functionality.

In this embodiment, the tablet 302 includes a control button 304, a camera 306 and a display 308. The orientation, design and layout of the tablet 302 and the component parts are for illustrative purposes only. For example, in some embodiments, the control button 304 may be removed and/or replaced with an alternative control feature, such as a switch, a tactile control, an induction control, a voice control, an optical sensor, and/or other control feature. For another example, the camera 306 may be located on a different surface or side of tablet 302 than the display 308. In some embodiments, the tablet 302 may include multiple control buttons 304, cameras 306 and displays 308. In some embodiments, the tablet 302 may include additional components integrated into the tablet 302 or operably associated with the tablet 302, such as a microphone, a card reader and/or other device.

In this embodiment, the display 308 is a touch screen which may be utilized as part of a user interface in place of or in conjunction with other components such as button 304. In this embodiment, the display 308 shows an information box 310, a series of touch screen controls depicted as buttons and a map layout 318. In some embodiments, alternative touch screen controls may be used, such as slide controls, switches and other touch screen controls. In the embodiment shown, the buttons include a new property button 312, an existing property button 314 and an address button 316. In some embodiments, the display 308 may include one or more areas designated for advertising, promotions and/or other information. Such areas may vary among the variety of screens discussed herein. In some embodiments, such advertising, promotions and/or other information may be targeted to a user based upon information related to the user, the location and/or the operations.

In this embodiment, the display 308 shows the information box 310 regarding inspector information. In some embodiments, the information box 310 may relate to other information in addition to and/or instead of the inspector information. In some embodiments, selecting the information box 310 may provide additional information. In some embodiments, one or more of information boxes may be modifiable using one or more controls associated with tablet 302 and the screen 308 shown in FIG. 3. For example, the information box 310 may be modifiable through selection of the information box. In some embodiments, one or more of the information boxes are not modifiable through the screen 308 shown in FIG. 3. For example, information box 310 may be based upon the information input through a different screen and not modifiable through the screen shown in FIG. 3.

The new property button 312 may be operable to indicate that the system is setting up a new property that is not already in the system and/or associated with the user of tablet 302. When selecting the new property button 312, the application may open one or more windows or screens for inputting property identifying information, including one or more checklists for the use to complete in order to set up the new property and collect relevant data regarding features of the new property. In some embodiments, the application will populate the new property information with the information shown on the map layout 318 or the address button 316 as a default.

The existing property button 314 may be operable to indicate that the system is reviewing or updating an existing property that is already in the system and/or associated with the user of tablet 302. When selecting the existing property button 312, the application may open one or more windows or screens associated with information regarding the property. The windows or screens may provide a summary status associated with the existing property. For example, one screen may provide a list of the next few maintenance reminders associated with features of the house. For another example, a screen may show a summary of the property description. In some embodiments, the application will identify the existing property through a search based upon the information shown on the map layout 318 or the address button 316 as a default.

The address button 316 may be operable to identify the location of the property. In some embodiments, the default information associated with address button 316 is based upon the information shown on the map layout 318. When selecting the address button 316, the application may open one or more windows or screens to facilitate updating or refining the address information associated with a desired property.

For example, the windows or screens may provide a form for a use to complete. For example, the form may include text blocks which may be used to identify the address.

In this embodiment, the map layout 318 shows an icon 320 which indicates the location of the property. In some embodiments, the map layout 318 may be generated based upon a navigation or mapping operation associated with the tablet 302, and the icon 320 may default to the current location of the tablet 302. In some embodiments, the user will select the icon location manually using the button 304 or other controls, such as the touch screen controls. For example, the user may input the address using the address button 316, wherein the system will associate the icon 320 location with the address identified through the address button 316.

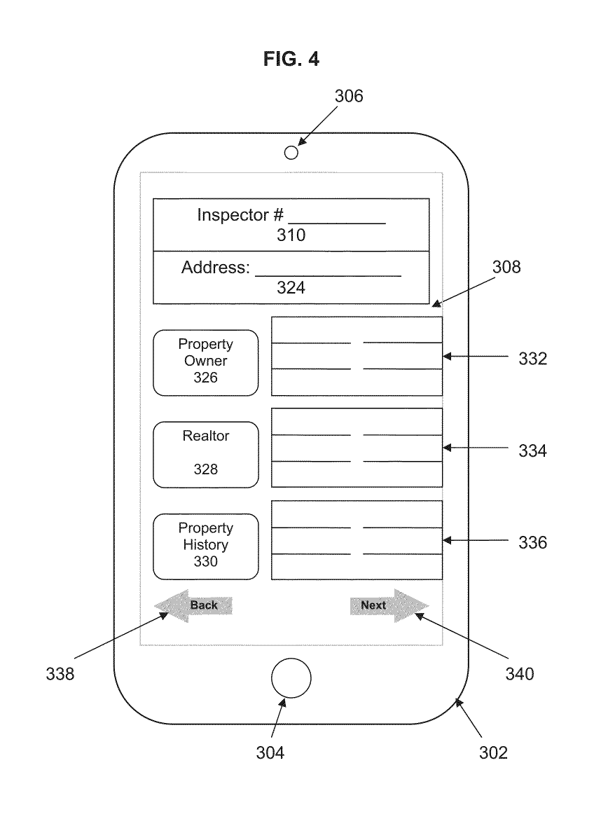

FIG. 4 depicts the tablet 302 showing another screen associated with an embodiment of software for collecting, reviewing and/or updating information regarding a property. As discussed in FIG. 3, the tablet 302 includes a control button 304, a camera 306 and a display 308 in this embodiment. The controls, components and outputs of the tablet 302 may vary and remain within the scope and spirit of the present disclosure. In some embodiments, this screen may be accessible through selection of the new property button 312 and/or the existing property button 314 shown in FIG. 3.

In this embodiment, the display 308 shows a series of information boxes and a series of touch screen controls depicted as buttons. In some embodiments, alternative touch screen controls may be used, such as slide controls, switches and other touch screen controls. The information boxes shown in this embodiment include the information box 310 regarding inspector information, the second information box 324 regarding address information, the property owner information box 332, the realtor information box 334 and the property history information box 336. In some embodiments, one or more of the information boxes may be modifiable using one or more controls associated with tablet 302 and the screen shown in FIG. 4. For example, the information boxes 332, 334 and 336 may be modifiable through selection of the corresponding touch screen buttons 326, 328 and 330. In some embodiments, one or more of the information boxes are not modifiable through the screen shown in FIG. 4. For example, information boxes 310 and 324 may be based upon the property information input through a different screen and not modifiable through the screen shown in FIG. 4.

In the embodiment shown, the buttons include a property owner button 326, a realtor button 314 and a property history button 330. In addition, the back button 338 and next button 340 are shown to facilitate control of the system operation and allow a user to move to the previous screen or the next screen in the process.

In some embodiments, the property owner information box 332 may provide relevant information regarding a property owner, such as the name of the owner, contact information, purchase date and/or other information. In some embodiments, additional information may be available by pressing or touching the property owner information box 332. In some embodiments, selecting the property owner information box 332 allows a user to modify one or more information blocks within the property owner information box 332.

The property owner button 326 may be operationally associated with the property owner information box 332 which is shown adjacent to the property owner button 326. For example, the information shown in the property owner information box 332 may become modifiable when the property owner button 326 is selected. In some embodiments, the property owner button 326 may provide information that is not shown in the property owner information box 332.

Similar to the property owner information box 332 discussed above, the realtor information box 334 may provide relevant information regarding a realtor associated with the property, such as the name of the realtor, contact information, company affiliation, prior work associated with the property or the identified property owner and/or other information. Pressing or touching the realtor information box 334 may provide additional information regarding the realtor and/or allows a user to modify one or more information blocks within the realtor information box 334.

The realtor button 328 may be operationally associated with the realtor information box 334 which is shown adjacent to the realtor button 328. For example, the information shown in the realtor information box 334 may become modifiable when the realtor button 328 is selected. In some embodiments, the realtor button 328 may provide information that is not shown in the realtor information box 334.

In some embodiments, the property history information box 336 may provide relevant information regarding the history of a property, such as the year a structure on the property was built, structure category, structure age, square-footage of the structure, subdivision associated with the property and/or other information. In some embodiments, additional information may be available by pressing or touching the property history information box 336. In some embodiments, selecting the property history information box 336 allows a user to modify one or more information blocks within the property history information box 336.

The property history button 330 may be operationally associated with the property history information box 336 which is shown adjacent to the property history button 330. For example, the information shown in the property history information box 336 may become modifiable when the property history button 330 is selected. In some embodiments, the property history button 330 may provide information that is not shown in the property history information box 336.

In some embodiments, the application may be used by a property inspector during an inspection. The screen shown in FIG. 4 may be completed by an inspector or populated through alternative methods to provide information to the inspector. For example, the information provided in the information boxes 332, 334 and 336 may be downloaded from realtor records, property appraisal databases, a previously completed form associated with the inspection and/or a combination of these and other information sources. In some embodiments, an inspection request form may be used to request the inspection and populate the property and realtor information. The form may be an electronic form which is transferrable or a paper form that is readable through optical recognition. In some embodiments, various users of the application may complete alternative information sections and share the information through direct device communications, such as a Bluetooth® communication or other communication capability, or through separate connections with the remote database associated with the system.

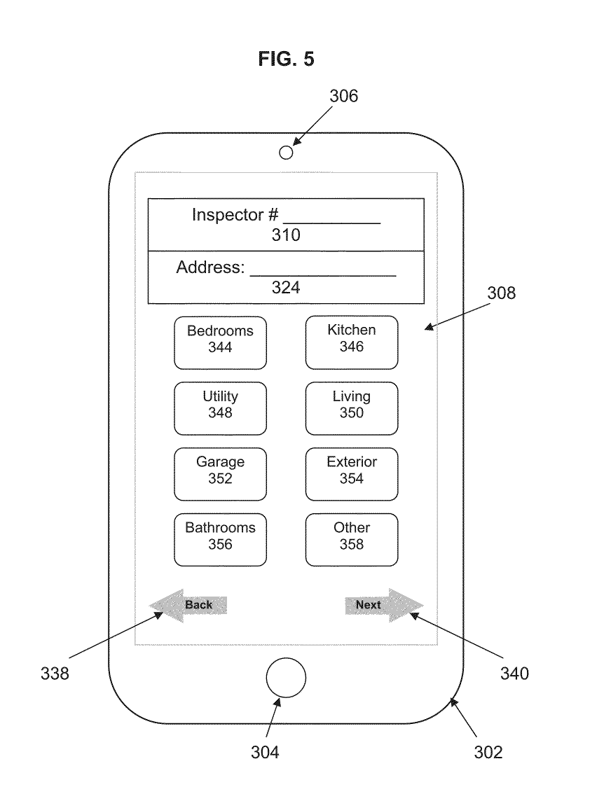

FIG. 5 depicts the tablet 302 showing another screen associated with an embodiment of software for collecting, reviewing and/or updating information regarding a property. As discussed elsewhere herein, the tablet 302 includes a control button 304, a camera 306 and a display 308 in this embodiment. The controls, components and outputs of the tablet 302 may vary and remain within the scope and spirit of the present disclosure. In some embodiments, this screen may be accessible through selection of the next button 340 shown in FIG. 4.

In this embodiment, the display 308 shows the information box 310 regarding inspector information and the second information box 324 regarding address information in the header area of the display 308. One skilled in the art will recognize that the placement of information boxes and buttons in the application screens may vary and remain within the spirit and scope of the present disclosure. In addition, the back button 338 and next button 340 are shown to facilitate control of the system operation and allow a user to move to the previous screen or the next screen in the process.

In this embodiment, the display 308 also shows a series of touch screen controls depicted as buttons. In some embodiments, alternative touch screen controls may be used, such as slide controls, switches and other touch screen controls. In the embodiment shown, the buttons relate to various property features that may be applicable to the property and include a bedrooms button 344, a kitchen button 346, a utility button 348, a living button 350, a garage button 352, an exterior button 354, a bathrooms button 356 and an other button 358. The categories of buttons shown in this embodiment are for illustrative purposes only and may vary in other screens or embodiments. For example, other embodiments may remove one or more of the buttons or categories shown, include additional buttons or categories to those shown and/or include alternative buttons or categories to those shown.

In some embodiments, the selection of buttons available on this screen and other screens may be tailored to a prior property description associated with the property. For example, the garage button 352 may not appear for a property that does not include a garage. In some embodiments, the buttons may be limited to options based upon the property description available from a real estate listing, a property appraisal, a third party description and/or other information sources. In some embodiments which limit the options, the application may provide for alternative means to access features that are not shown in the selected options. During an inspection process wherein the application is tailored to the specific property, the application may include alerts, warnings, reminders and/or other indications that additional property features are associated with the property and should be reviewed.

In some embodiments, the buttons are not tailored to a specific property. In such embodiments, the user may select buttons associated with property features identified during the inspection process, and may skip buttons associated with property features that are not applicable to the specific property. In some embodiments, the system may require and/or allow the user to indicate which features are not applicable to the property.

The category buttons 344-358 may be operable to facilitate the collection and/or review of information regarding one or more features associated with the selected category. For example, selecting the bedrooms button 344 may provide information and/or allow the input of information regarding features associated with one or more bedrooms, such as the status of electrical outlets, window seals and/or other features. When selecting one of the category buttons 344-358, the application may open one or more windows or screens associated with the selected category or features associated with the selected category. The windows or screens may provide a summary status associated with the features of associated with the category. For example, one screen may provide a list of the features previously associated with the category. For another example, a screen may show a percent complete or other indicator of the extent of information previously supplied associated with the features of the category.

In some embodiments, selection of one of the category buttons 344-358 will open a new application screen that will facilitate collection and/or review of information relating to specific features associated with the selected category. For example, the selection of the kitchen button 346 may open another screen with feature buttons which will facilitate collection or review of feature specific information. One skilled in the art will recognize that the process for providing the collection and/or review capabilities may include the use of one of more screens to categorically organize the selection and search for features and remain within the spirit and scope of the present disclosure. In addition, the number of potential layers in the application to identify features may vary. In some embodiments, the features may be identified through room categories, such as bathroom, kitchen, living rooms, etc., and type of feature, such as electrical, plumbing, temperature control, etc. In some embodiments, all features may be selectable from one screen. In some embodiments, the application will include a search option to allow property features to be identified using the search function. Depending on the method for identifying a property feature, more or less information may be required when completing steps to fully identify a property feature. For example, if the property feature is identified using a category button, such as the garage button 352, the application may populate a location field with the selected category (i.e. garage) to indicate the feature is associated with the selected category. For another example, if the property feature is identified without using the category process, a user may need to complete further information identifying the location of the feature.

When using this embodiment, the user may return to this screen to continue the data collection process for each applicable category. Within each category, the user may complete information regarding each sub-category and/or property feature that is applicable to the property. When the user is done collecting the data regarding these categories, chooses to identify features through an alternative process, and/or chooses to return or proceed to other screens of the application, the user may select either the back button 338 or next button 340.

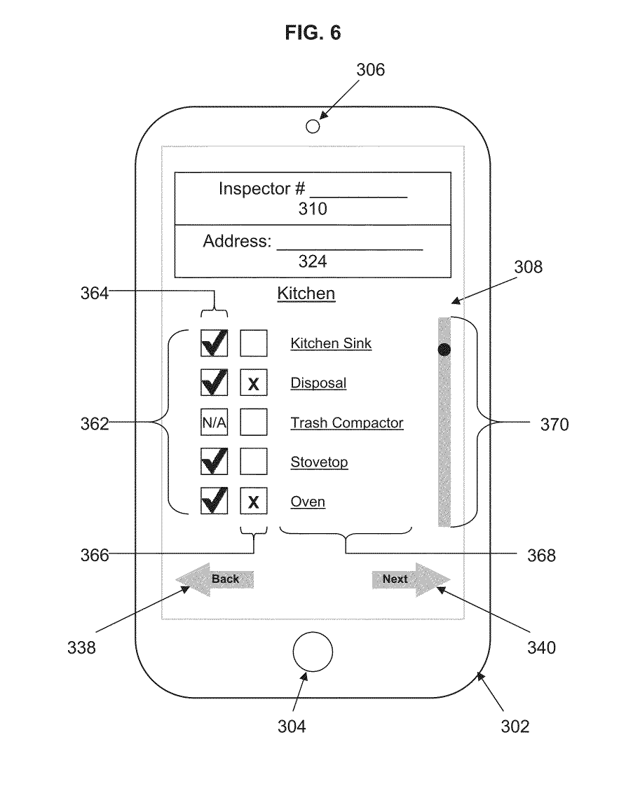

FIG. 6 depicts the tablet 302 showing another screen associated with an embodiment of software for collecting, reviewing and/or updating information regarding a property. As discussed elsewhere herein, the tablet 302 includes a control button 304, a camera 306 and a display 308 in this embodiment. The controls, components and outputs of the tablet 302 may vary and remain within the scope and spirit of the present disclosure. In this embodiment, the display 308 shows the information box 310 regarding inspector information and the second information box 324 regarding address information in the header area of the display 308. In addition, the back button 338 and next button 340 are shown to facilitate control of the system operation and allow a user to move to the previous screen or the next screen in the process.

In the illustrative embodiment shown, the screen facilitates data input and/or review of features associated with a kitchen. In this embodiment, application may have one or more additional categorical information screens related to alternative categories associated with a property. In some embodiments, this screen may be accessible through selection of the kitchen button 346 shown in FIG. 5. This screen may also be accessed through other system operations.

In this embodiment, the display 308 also shows a feature review checklist 362 that includes status boxes 364 and 366 related to identified property features 368 and a slide control 370 to view additional features and information boxes. In some embodiments, alternative touch screen controls may be used, such as buttons, switches and other touch screen controls. In the embodiment shown, the various property features and status boxes may also operate as buttons which may facilitate collection or review of specific data associated with the property feature.

The structure of information shown in this embodiment is for illustrative purposes only and may vary in other screens or embodiments. For example, other embodiments may remove one or more of the status boxes or feature identifications shown, include additional status boxes or feature identifications to those shown and/or include alternative status boxes or feature identifications to those shown.

In the illustrative embodiment shown, the status boxes 364 are used to indicate that the identified feature has been reviewed or the identified feature is not applicable to the property. For example, the checks in some of the status boxes 364 may indicate that the property has the identified feature and it has been reviewed while the “N/A” shown in one of the status boxes 364 indicates the property does not have the associated property feature. In some embodiments, additional information may be indicated based upon the look of each status boxes. For example, in addition to a symbol, each status box 364 may include a color background which could indicate whether the feature is historically associated with the property based upon a prior inspection or another information source.

In the illustrative embodiment shown, the status boxes 366 are used to indicate a problem, notation, status update and/or other information is associated with the identified feature. For example, the “X” shown next to the disposal shown in the identified feature column 368 may indicate that the inspector has identified a problem with the disposal, such as stuck rotors, a leak and/or another problem. In some embodiments, another screen and/or window that allows additional information to be provided may be accessible when a user inputs a relevant symbol into one of the status boxes 366. For example, when a user inputs the “X” next to the oven feature, a screen may appear providing one or more options for the user to indicate the identified problem. In some embodiments, the options may include providing pictures depicting the problem, inserting a text description, selecting a problem from a series of potential problems and/or other options for providing information.

During operation, a user may input information into each status box 364 and/or status box 366 using one or more input controls, such as voice controls, a keyboard, touch screen systems, optical recognition systems and/or other input mechanisms. For example, a user may touch one status box 364 causing the application to show a screen with a variety of selectable options, such as the check symbol or the “N/A” symbol, to fill in the status box 364. For another example, the application may facilitate voice controls to allow a user to speak into a microphone with instructions for the tablet 302 to fill in status boxes 364 and/or 366. As yet another example, the application may facilitate an optical recognition system whereby the tablet 302 can take a picture using camera 306 and the application will recognize the property feature in the picture and populate the status box 364 based upon the picture.

In some embodiments, the identified property features 368 may operate as buttons whereby selecting a property feature shown may open another screen and/or window to facilitate the collection of data and/or reviewing of information relating to the selected property feature. For example, a user may select the stovetop feature to open a window and input data regarding the stovetop located on the property, such as the make and model of the stovetop, the age of the stovetop, any warranties associated with the stovetop, and/or any additional information that may be associated with the stovetop.

In some embodiments, the user may view additional property features and complete the applicable status boxes 364 and/or 366 as appropriate. In the embodiment shown, the display includes the slide control 370 which facilitates viewing one or more additional property features. In some embodiments, the system may automatically shift the viewable features to those property features with status boxes 364 and 366 which have not been completed and/or updated.

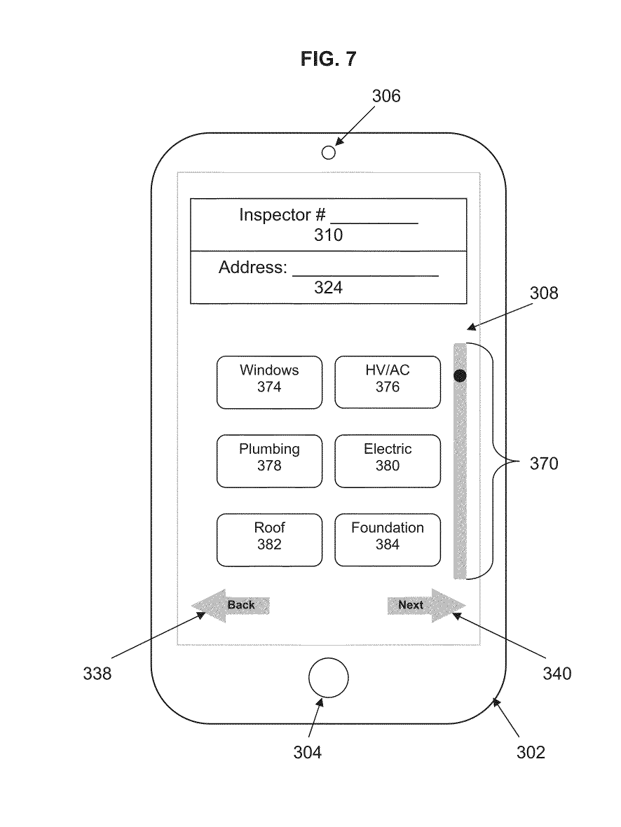

FIG. 7 depicts the tablet 302 showing another screen associated with an embodiment of software for collecting, reviewing and/or updating information regarding a property. As discussed elsewhere herein, the tablet 302 includes a control button 304, a camera 306 and a display 308 in this embodiment. The controls, components and outputs of the tablet 302 may vary and remain within the scope and spirit of the present disclosure.

In this embodiment, the display 308 shows the information box 310 regarding inspector information and the second information box 324 regarding address information in the header area of the display 308. In addition, the back button 338 and next button 340 are shown to facilitate control of the system operation and allow a user to move to the previous screen or the next screen in the process.

In this embodiment, the display 308 also shows a series of touch screen controls depicted as buttons. In some embodiments, alternative touch screen controls may be used, such as slide controls, switches and other touch screen controls. The embodiment shown provides an alternative set of categorical buttons to those described in relation to FIG. 5 which related to categories of locations or rooms. In some embodiments, the categorical buttons in FIG. 7 may operate as sub-categories or classifications associated with the categories selected in FIG. 5. In some embodiments, this screen may be accessible through selection of the next button 340 shown in FIG. 4. This screen may also be accessed through other system operations.

In the embodiment shown, the buttons relate to various categories of property features that may be applicable to the property and include a windows button 374, an HV/AC button 376, a plumbing button 378, an electric button 380, a roof button 382 and a foundation button 384. The categories of buttons shown in this embodiment are for illustrative purposes only and may vary in other screens or embodiments. For example, other embodiments may remove one or more of the buttons or categories shown, include additional buttons or categories to those shown and/or include alternative buttons or categories to those shown. In this embodiment additional category buttons may be accessible using the slide control 370. In some embodiments, application may have one or more additional categorical information screens related to alternative categories associated with a property.

In some embodiments, the selection of buttons available may be tailored to a prior property description associated with the property. For example, a pool button may not appear for a property that does not include a pool. In some embodiments, the buttons may be limited to options based upon the property description available from a real estate listing, a property appraisal, a third party description and/or other information sources. In some embodiments which limit the options, the application may provide for alternative means to access features that are not shown in the selected options. During an inspection process wherein the application is tailored to the specific property, the application may include alerts, warnings, reminders and/or other indications that additional property features are associated with the property and should be reviewed.

In some embodiments, the buttons are not tailored to a specific property. In such embodiments, the user may select buttons associated with property features identified during the inspection process, and may skip buttons associated with property features that are not applicable to the specific property. In some embodiments, the system may require and/or allow the user to indicate which features are not applicable to the property.

The category buttons 374-384 may be operable to facilitate the collection and/or review of information regarding one or more features associated with the selected category. For example, selecting the HV/AC button 376 may provide information and/or allow the input of information regarding features associated with one or more heating and air conditioning features and/or operations, such as the air conditioning condenser, the furnace, the blower, air vents and/or other features. When selecting one of the category buttons 374-384, the application may open one or more windows or screens associated with the selected category or features associated with the selected category. The windows or screens may provide a summary status associated with the features of associated with the category. For example, one screen may provide a list of the features previously associated with the category. For another example, a screen may show a percent complete or other indicator of the extent of information previously supplied associated with the category.

In some embodiments, selection of one of the category buttons 374-384 will open a new application screen that will facilitate collection and/or review of information relating to specific features associated with the selected category. For example, the selection of the electric button 380 may open another screen with feature buttons which will facilitate collection or review of feature specific information. One skilled in the art will recognize that the process for providing the collection and/or review capabilities may include the use of one of more screens to categorically organize the selection and search for features and remain within the spirit and scope of the present disclosure. In addition, the number of potential layers in the application to identify features may vary. Depending on the method for identifying a property feature, more or less information may be required when completing steps to fully identify a property feature. For example, if the property feature is identified using a category button, such as the roof button 382, the application may populate a field with the selected category (i.e. roof) to indicate the feature is associated with the selected category. For another example, if the property feature is identified without using the category process, a user may need to complete further information identifying the location of the feature.

When using this embodiment, the user may return to this screen to continue the data collection process for each applicable category. Within each category, the user may complete information regarding each sub-category and/or property feature that is applicable to the property. When the user is done collecting the data regarding these categories, chooses to identify features through an alternative process, and/or chooses to return or proceed to other screens of the application, the user may select either the back button 338 or next button 340.

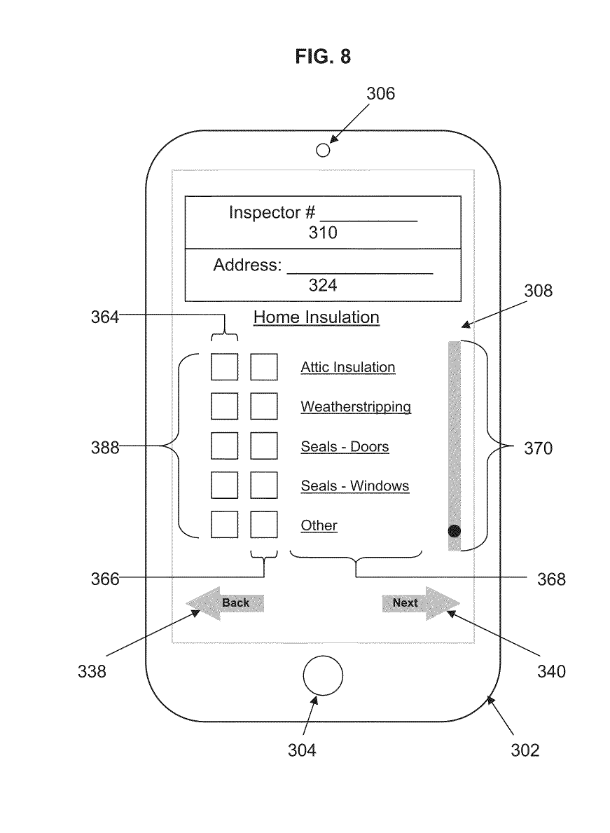

FIG. 8 depicts the tablet 302 showing another screen associated with an embodiment of software for collecting, reviewing and/or updating information regarding a property. As discussed elsewhere herein, the tablet 302 includes a control button 304, a camera 306 and a display 308 in this embodiment. The controls, components and outputs of the tablet 302 may vary and remain within the scope and spirit of the present disclosure. In this embodiment, the display 308 shows the information box 310 regarding inspector information and the second information box 324 regarding address information in the header area of the display 308. In addition, the back button 338 and next button 340 are shown to facilitate control of the system operation and allow a user to move to the previous screen or the next screen in the process.

In the illustrative embodiment shown, the screen facilitates data input and/or review of features associated with the property's home insulation features. In this embodiment, application may have one or more additional categorical information screens related to alternative categories associated with a property. In some embodiments, this screen may be accessible through selection of a button associated with the screen shown in FIG. 7. This screen may also be accessed through other system operations.

In this embodiment, the display 308 also shows a feature review checklist 388 that includes status boxes 364 and 366 related to identified property features 368 and a slide control 370 to view additional features and information boxes. In some embodiments, alternative touch screen controls may be used, such as buttons, switches and other touch screen controls. In the embodiment shown, the various property features and status boxes may also operate as buttons which may facilitate collection or review of specific data associated with the property feature.

The structure of information shown in this embodiment is for illustrative purposes only and may vary in other screens or embodiments. For example, other embodiments may remove one or more of the status boxes or feature identifications shown, include additional status boxes or feature identifications to those shown and/or include alternative status boxes or feature identifications to those shown.

In the illustrative embodiment shown, the depicted portion of the feature review checklist 388 is blank. In some embodiments, the blank feature review checklist 388 may indicate that a user has not completed the depicted section. In some embodiments, the blank feature review checklist 388 may indicate that there is no additional information regarding the features shown. The meaning of the blank feature review checklist 388 and/or any indicators may vary and remain within the scope and spirit of the present disclosure.

In some embodiments, the status boxes 364 may be used to indicate that the identified feature has been reviewed or the identified feature is not applicable to the property. For example, a user may input a symbol in the status boxes 364 to indicate that the property has the identified feature and it has been reviewed. In some embodiments, the user may input an “N/A” symbol in one of the status boxes 364 to indicate the property does not have the associated property feature. In some embodiments, additional information may be indicated based upon the look of each status boxes. For example, in addition to a symbol, each status box 364 may include a color background which could indicate whether the feature is historically associated with the property based upon a prior inspection or another information source.

In the illustrative embodiment shown, the status boxes 366 may be used to indicate a problem, notation, status update and/or other information is associated with the identified feature. For example, an “X” may be input next to the “Seals-Doors” in the identified feature column 368 to indicate that the inspector has identified a problem with the door seals, such as significant signs of wear and tear, a leak and/or another problem. In some embodiments, another screen and/or window allowing additional information to be provided may be accessible when a user inputs a relevant symbol into one of the status boxes 366. For example, when a user inputs an “X” next to the weather stripping feature, a screen may appear providing one or more options for the user to indicate the identified problem. In some embodiments, the options may include providing pictures depicting the problem, inserting a text description, selecting a problem from a series of potential problems and/or other options for providing information.

During operation, a user may input information into each status box 364 and/or status box 366 using one or more input controls, such as voice controls, a keyboard, touch screen systems, optical recognition systems and/or other input mechanisms. For example, a user may touch one status box 364 causing the application to show a screen with a variety of selectable options, such as the check symbol or the “N/A” symbol, to fill in the status box 364. For another example, the application may facilitate voice controls to allow a user to speak into a microphone with instructions for the tablet 302 to fill in status boxes 364 and/or 366. As yet another example, the application may facilitate an optical recognition system whereby the tablet 302 can take a picture using camera 306 and the application will recognize the property feature in the picture and populate the status box 364 based upon the picture.

In some embodiments, the identified property features 368 may operate as buttons whereby selecting a property feature shown may open another screen and/or window to facilitate the collection of data and/or reviewing of information relating to the selected property feature. For example, a user may select the attic insulation feature to open a window and input data regarding the attic insulation for the property, such as the insulation type, depth, age and/or any additional information that may be associated with the attic insulation.

In some embodiments, the user may view additional property features and complete the applicable status boxes 364 and/or 366 as appropriate. In the embodiment shown, the display includes the slide control 370 which facilitates viewing one or more additional property features. In some embodiments, the system may automatically shift the viewable features to those property features with status boxes 364 and 366 which have not been completed and/or updated.

In the embodiments shown, the identified property features 368 include an “other” category which may be used to input additional information regarding one or more features that are not listed in the identified property features 368. In some embodiments, any additional features identified using the “other” category may be added to the identified property features 368 associated with the selected property.

In some embodiments, a server associated with one or more tablets 302 may receive a plurality of property reports, and determine whether a feature that is identified through the “other” category for one or more reports should be included as a standard feature option under the identified property features 368. In some embodiments, the server or other portion of the system may add or remove features based upon a statistical analysis of the likelihood that such a feature is applicable to a given property.

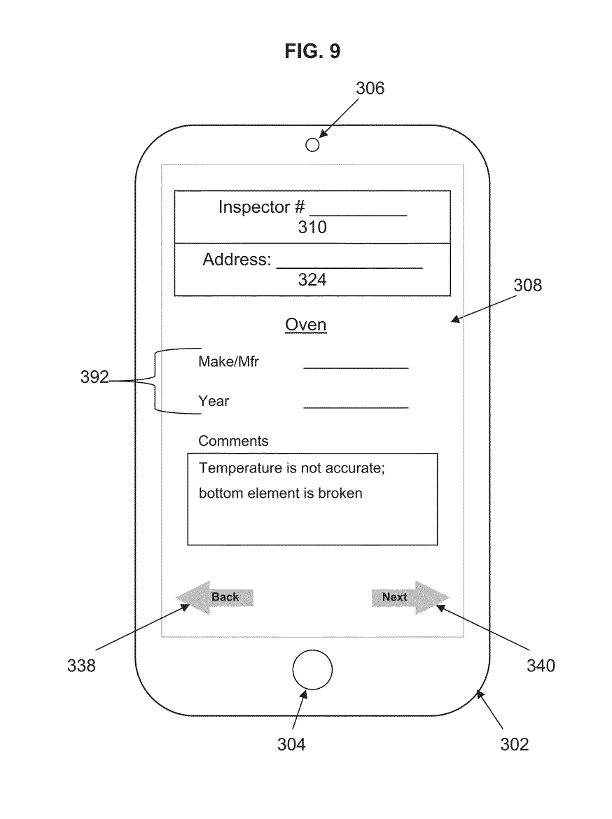

FIG. 9 depicts the tablet 302 showing another screen associated with an embodiment of software for collecting, reviewing and/or updating information regarding a property. As discussed elsewhere herein, the tablet 302 includes a control button 304, a camera 306 and a display 308 in this embodiment. The controls, components and outputs of the tablet 302 may vary and remain within the scope and spirit of the present disclosure. In this embodiment, the display 308 shows the information box 310 regarding inspector information and the second information box 324 regarding address information in the header area of the display 308. In addition, the back button 338 and next button 340 are shown to facilitate control of the system operation and allow a user to move to the previous screen or the next screen in the process.

In the illustrative embodiment shown, the screen facilitates data input and/or review of a feature—the oven. In this embodiment, the application may have one or more additional feature information screens related to alternative features associated with a property. In some embodiments, this screen may be accessible through selection of a button associated with the screen shown in FIG. 6. This screen may also be accessed through other system operations.

In this embodiment, the display 308 also shows a feature identification section 392 related to information about the feature, such as the make and manufacturer of the oven as well as the year the oven was built. The structure of information shown in this embodiment is for illustrative purposes only and may vary in other screens or embodiments. For example, other embodiments may remove one or more of the identification elements shown, include additional identification elements to those shown and/or include alternative identification elements to those shown. In the embodiment shown, the feature identification section may also include buttons which may facilitate collection or review of specific data associated with the property feature.

In the illustrative embodiment shown, screen also included a comment box 394, wherein a user may include additional information regarding the feature. For example, the comments box 394 may be completed by an inspector to include observations regarding the feature—such as the oven temperature is inaccurate and/or the heating elements are broken. In some embodiments, the comments box 394 may include visual, audio and/or other types of information regarding the feature, such as pictures of the problems, voice descriptions of the observations, vendor links to provide price comparisons and/or other information.

During operation a user may follow the application screens in conjunction with a review of the property to populate a property report identifying the various features of the property. The user may use various operations available on the screens of the application, including the back button 338, the next button 340 and/or additional buttons and controls to navigate the application and fill in relevant information regarding the property. Following the completion of a property report and/or at an intermediate point in the system application, the system may save the property report. In some embodiments, the application may automatically operate to transmit the report and/or a portion of the report to a remote server and/or database. In some embodiments, the user may operate the application to transmit the report and/or a portion of the report to a remote server and/or database. In some embodiments, the application may prompt a user to transmit the report and/or a portion of the report to a remote server and/or database. In some embodiments, the prompt may be based upon a triggering threshold (such as a data capacity), a schedule and/or another basis.

In some embodiments, the system may conduct an analysis of the property report to improve a property description and/or property application. If the property previously existed in the system, the new property report may be compared to a prior report to determine updates to the property, identify potential errors in one of the property reports and/or for other purposes. As part of an analysis, the system may associate additional information with features identified in the property report in some embodiments. For example, the system may identify the manufacturer, make and model of each appliance or feature and associate each identified feature with the manufacturer website (or third party website) related to the specific appliance or feature. For another example, the system may associate the feature with one or more information websites, such as feature description websites, maintenance instruction websites and/or other information sites. As yet another example, the system may associate vendor websites with related features.

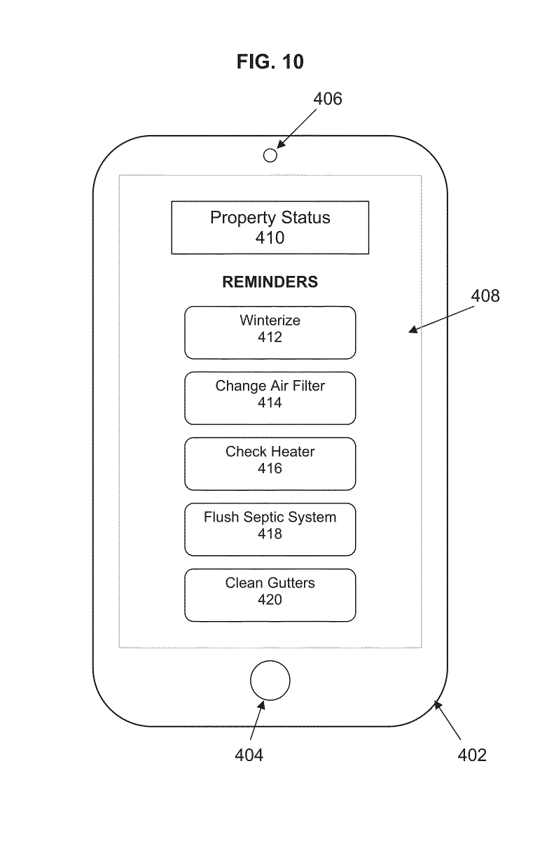

FIG. 10 depicts a mobile phone 402 operating another embodiment of software for collecting, reviewing and/or updating information regarding a property. For illustrative purposes, the mobile phone 402 will be discussed primarily as a property owner's device; however, one skilled in the art will recognize that the mobile phone 402 may be associated with a company, a vendor, an inspector, a handyman, a property owner and/or another person. One skilled in the art will recognize that the mobile phone 402 is used as an exemplary device, and the application and operation discussed in the context of mobile phone 402 may be implemented on alternative components, such as a laptop computer, a computer station, a tablet and/or any other devices suitable to perform the operations described. In some embodiments, a combination of devices may be implemented to achieve the desired operational functionality. In some embodiments, the application is operated through an internet portal.

In this embodiment, the mobile phone 402 includes a control button 404, a camera 406 and a display 408. The orientation, design and layout of the mobile phone 402 and the component parts are for illustrative purposes only. For example, in some embodiments, the control button 404 may be removed and/or replaced with an alternative control feature, such as a switch, a tactile control, an induction control, a voice control, an optical sensor, and/or other control feature. For another example, the camera 406 may be located on a different surface or side of mobile phone 402 than the display 408. In some embodiments, the mobile phone 402 may include multiple control buttons 404, cameras 406 and displays 408. In some embodiments, the mobile phone 402 may include additional components integrated into the mobile phone 402 or operably associated with the mobile phone 402, such as a microphone, a card reader and/or other device.

In this embodiment, the display 408 is a touch screen which may be utilized as part of a user interface in place of or in conjunction with other components such as button 404. In this embodiment, the display 408 shows an information box 410 and a series of touch screen controls depicted as reminder buttons 412-420. In some embodiments, alternative touch screen controls may be used, such as slide controls, switches and other touch screen controls. In the embodiment shown, the reminder buttons include a winterize button 412, a change air filter button 414, a check heater button 416, a flush septic system button 418 and a clean gutters button 420. In some embodiments, the display 408 may include one or more areas designated for advertising, promotions and/or other information. Such areas may vary among the variety of screens discussed herein. In some embodiments, such advertising, promotions and/or other information may be targeted to a user based upon information related to the user, the location and/or the operations.

In this embodiment, the display 408 shows the information box 410 regarding property status information. In some embodiments, the information box 410 may relate to other information in addition to and/or instead of the property status information. In some embodiments, selecting the information box 410 may provide additional information, such as an overall maintenance status of the property based upon the prior reports. In some embodiments, one or more of information boxes may be modifiable using one or more controls associated with the mobile phone 402 and the screen 408 shown in FIG. 10. For example, the information box 410 may be modifiable through selection of the information box. In some embodiments, one or more of the information boxes are not modifiable through the screen 408 shown in FIG. 10. For example, information box 410 may be based upon the information input through a different screen and not modifiable through the screen shown in FIG. 10.

Each of the reminder buttons 412-420 shown in FIG. 10 are for illustrative purposes. Other embodiments may remove one or more of the buttons or reminders shown, include additional buttons or reminders to those shown and/or include alternative buttons or reminders to those shown. In some embodiments, the screen may provide alternative information to reminders, such as warnings, emergency information and/or other information. In some embodiments, the buttons may be replaced by information boxes, wherein all pertinent information is provided on the screen.

In this embodiment, the reminder buttons 412-420 may be operable to provide additional information regarding a selected reminder. When selecting one of the reminder buttons 412-420, the application may open one or more windows or screens for providing information regarding the reminder and/or applicability to the property, including one or more maintenance instructions. In some embodiments, the application may allow a user to update the system using the reminder buttons 412-420. For example, a screen may open showing maintenance suggestions and facilitate inputting information regarding the completion, scheduling or other action regarding the reminder. In some embodiments, the application will populate the reminder information associated with each button 412-420 based upon characteristics associated with the relevant feature and/or the property. For example, upon selection of the change air filter button 414, the application may provide information regarding the proper type and size of filter to use in the specific air conditioner system located at the property.

In some embodiments, the application will populate and/or organize the reminder buttons 412-420 based upon characteristics associated with the property and/or specific property features. The characteristics may include suggested component replacement schedules, calendar reminders, estimated wear and tear, a feature's history and/or other characteristics. For example, the winterize button 412 may appear on the reminder list based upon a calendar reminder that is associated with the historical approach of cold weather in the geographic area associated with the property. In some embodiments, the winterize button 412 may appear on the reminder list based upon a weather report associated with the geographic area indicating a threshold temperature may occur within a given number of days. In some embodiments, the appearance of the winterize button 412 may depend upon an analysis of weather reports and the historical onset of cold weather in the geographic area. For example, the winterize button may appear at the earlier of the calendar date for the onset of winter weather or the first weather report indicating that a threshold temperature will be met within a certain number of days. One skilled in the art will recognize that the exemplary analysis regarding the appearance of the winterize button 412 may be applicable to other reminders.

In some embodiments, one or more reminders may be based upon the periodic replacement of consumable products or periodic maintenance recommendations. For example, the application may provide the change air filter button 414 every three months. For another example, the clean gutters button 420 may appear every year in the fall.

In some embodiments, reminders may appear based upon wear and tear observed and/or predicted. For example, the check heater button 416 may appear during the fall following the observation of wear and tear on the heating unit by an inspector. One skilled in the art will recognize that the basis and scheduling of the reminders and/or other buttons may vary and remain within the scope and spirit of the disclosure.

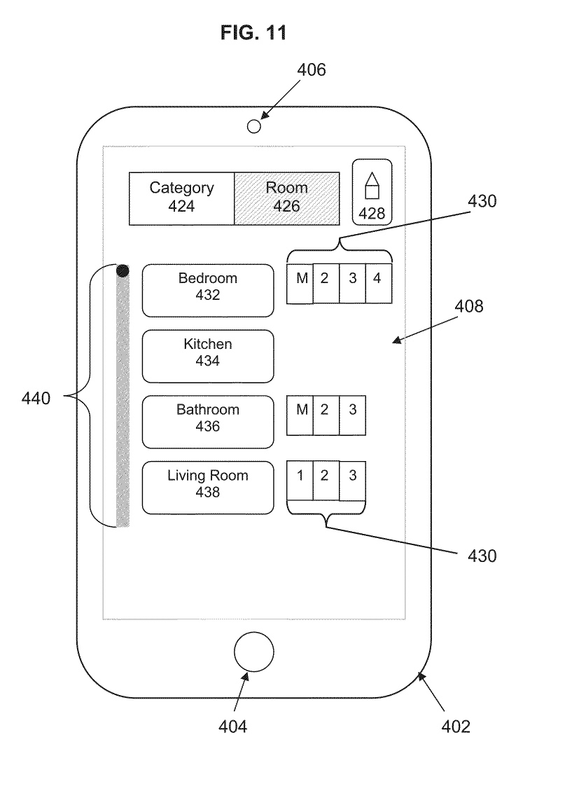

FIG. 11 depicts the mobile phone 402 showing another screen associated with an embodiment of software for collecting, reviewing and/or updating information regarding a property. As discussed elsewhere herein, the mobile phone 402 includes a control button 404, a camera 406 and a display 408 in this embodiment. The controls, components and outputs of the mobile phone 402 may vary and remain within the scope and spirit of the present disclosure.

In the illustrative embodiment shown, the screen facilitates selection of a category associated with the property. In this embodiment, application may have one or more additional categorical information screens related to alternative categories associated with a property. This screen may also be accessed through other system operations.

In this embodiment, the display 408 shows a toggle feature that allows a user to select between a search using a category button 424 and a room button 426. In the embodiment shown, the background of the selected button may have a different appearance than the unselected button to indicate which search organization is selected. For example, the room button 426 is shown with a darker background than the category button 424 indicating that the room button 426 has been selected. One skilled in the art will recognize that the background may vary in different ways to indicate a selected button and remain within the scope and spirit of the present disclosure. In some embodiments, the selection may not be indicated.

In this embodiment, the display also shows a home button 428, a series of touch screen controls depicted as buttons, a series of selectable options 430 associated with one or more of the buttons, and a slide control 440 to view additional buttons and selectable options. In some embodiments, the home button 428 will direct the application to return to a home screen associated with the application, the property within the application or a screen designated as the home screen.

In some embodiments, alternative touch screen controls may be used, such as switches and other touch screen controls. In the embodiment shown, the buttons relate to various property rooms that may be applicable to the property and include a bedroom button 432, a kitchen button 434, a bathroom button 436 and a living room button 438. The categories of buttons shown in this embodiment are for illustrative purposes only and may vary in other screens or embodiments. For example, other embodiments may remove one or more of the buttons or categories shown, include additional buttons or categories to those shown and/or include alternative buttons or categories to those shown.

In some embodiments, the selection of buttons 432-438 available on this screen and other screens may be tailored to a prior property description associated with the property. In some embodiments, the buttons 432-438 may be limited to options based upon the property description available from a real estate listing, a property appraisal, an inspection, a system property report, a third party description and/or other information sources. In some embodiments which limit the options, the application may provide for alternative means to access features that are not associated with the provided options.

In some embodiments, the buttons 432-438 are not tailored to a specific property. In such embodiments, the user may select buttons 432-438 associated with applicable property features, and may skip buttons 432-438 associated with property features that are not applicable to the specific property. In some embodiments, the system may require and/or allow the user to indicate which features are not applicable to the property.

The selectable options 430 may be used to refine the use of the associated buttons 432-438. For example, the selectable option 430 adjacent to the bedroom button 432 may be used to identify a specific bedroom, such as the master bedroom, the second bedroom, the third bedroom or the fourth bedroom. In some embodiments, multiple options may be identified using the selectable option 430. For example, a user may look for maintenance recommendations associated with the first and third living rooms by selecting the “1” and “3” from selectable option 430 adjacent to the living room button 438.

In conjunction with the selectable option 430, the buttons 432-438 may be operable to facilitate the collection and/or review of information regarding one or more features associated with the selected category. For example, selecting the bedroom button 432 and the “M” from the selectable option 430 may provide information and/or allow the input of information regarding features associated with the master bedroom, such as the status of electrical outlets, window seals and/or other features. When selecting one of the category buttons 432-438, the application may open one or more windows or screens associated with the selected category or features associated with the selected category. The windows or screens may provide a summary status associated with the features of associated with the category. For example, one screen may provide a list of the features previously associated with the category. For another example, a screen may show a percent complete or other indicator of the extent of information previously supplied associated with the features of the category.

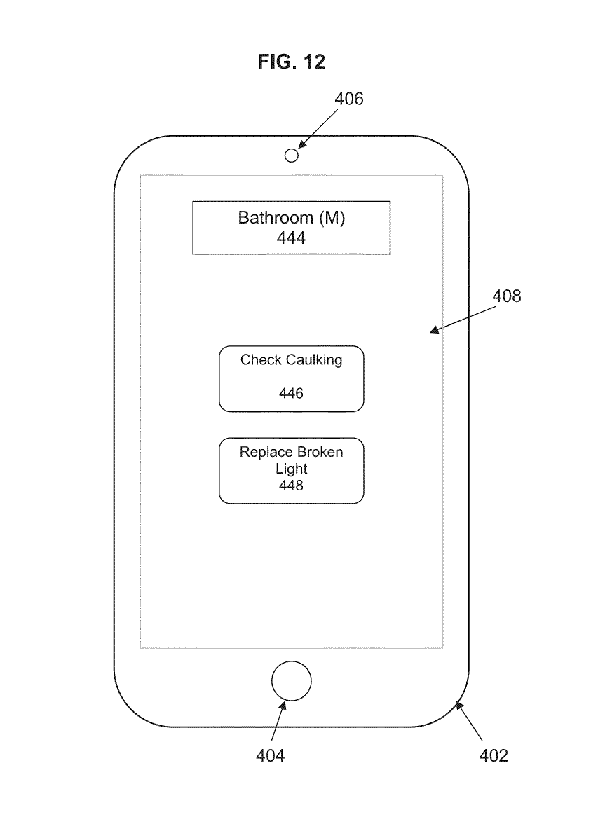

FIG. 12 depicts the mobile phone 402 showing another screen associated with an embodiment of software for collecting, reviewing and/or updating information regarding a property. As discussed elsewhere herein, the mobile phone 402 includes a control button 404, a camera 406 and a display 408 in this embodiment. The controls, components and outputs of the mobile phone 402 may vary and remain within the scope and spirit of the present disclosure.

In the illustrative embodiment shown, the screen provides one or more reminders associated with property category, such as a location on the property. In some embodiments, the application may have one or more additional reminder screens related to alternative categories associated with a property. In some embodiments, this screen may be accessed through selection of the bathroom button 436 and the “M” from the selectable option 430 shown in FIG. 11. This screen may also be accessed through other system operations.

In this embodiment, the display 408 shows an information box 444 near the top. The location of the information box 444 on the display may vary and remain within the scope and spirit of the present disclosure. In this embodiment, the information box 444 identifies the master bathroom as the relevant category. The information box 444 may identify any number of potential locations on the property, property systems and/or other property categories to which the screen applies and remain within the scope and spirit of the present disclosure. In some embodiments, the information box 444 may indicate a status level associated with each entry provided in the screen.

In some embodiments, separate categories may be provided as headers or table breaks instead of separate screens. For example, one screen may provide all the relevant reminders for the property and include the title of each category in close proximity to each reminder. In some embodiments, the screens may include features to navigate more reminders than those able to be shown on one screen. For example, an application may include a scroll feature, a pagination feature allowing multiple pages with a limited number of reminders to be viewed page by page or other features to allow additional entries.

In this embodiment, the display also shows reminders 446 and 448 which provide information regarding repair and/or maintenance activities associated with the category defined in the information box 444. In the embodiment shown, the reminders relate to specific maintenance items applicable to master bathroom on the property and include a check caulking reminder 446 and a replace broken light reminder 448. The reminders shown in this embodiment are for illustrative purposes only and may vary in other screens or embodiments. In some embodiments, each reminder may be color or design coded to indicate additional information regarding the reminder. In some embodiments, each color may indicate an importance level associated with the reminders 446 and 448. For example, the check caulking reminder 446 may include a yellow background to indicate a standard warning reminder, while the replace broken light reminder 448 may include a red background indicating a higher urgency than the check caulking reminder 446. One skilled in the art will recognize that the depicted reminders may be based upon a manufacturer's maintenance recommendations, a consumable product's anticipated life, weather, user inputs and/or other conditions.

In some embodiments, the reminders 446 and 448 may also operate as touch screen buttons. In some embodiments, alternative touch screen controls may be used, such as switches and other touch screen controls. When selecting one of the reminders 446 and 448, the application may open one or more windows or screens associated with the selected reminder. In some embodiments, the windows or screens may provide a summary status associated with the reminder. For example, one screen may indicate that a vendor has been scheduled to address the reminder.

In some embodiments, the reminders 446 and 448 may be operable to provide additional information regarding the maintenance item including the length of time in which the reminder has been active, the risk or benefit associated with the reminder, instructive information associated with the maintenance item, the basis for the reminder—such as a periodic time-based reminder, a prior inspection report, a user entry and/or other basis for the reminder—and/or other information regarding the maintenance item. For example, selecting the check caulking reminder 446 may provide information regarding the standard timeframe for checking the caulk, risks caused by bad seals in the bathroom, images of good and bad caulking and contact information to identify a vendor associated with offering caulking goods or services. In some embodiments, the reminder may also provide one or more links to additional information. For example, pressing the replace broken light reminder 448 may open a window providing a variety of links related to the reminder such as a link to vendors selling lighting supplies, a link to an electrician's website, a do-it-yourself website and/or other relevant links.

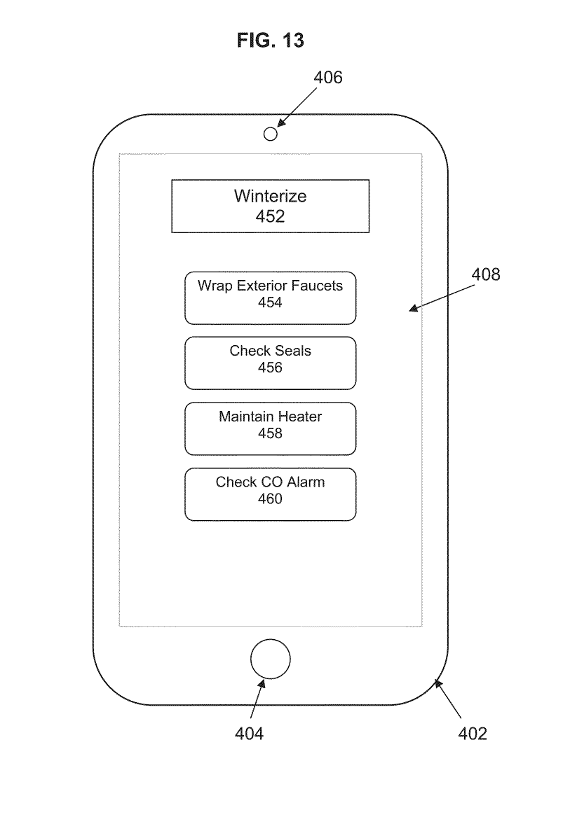

FIG. 13 depicts the mobile phone 402 showing another screen associated with an embodiment of software for collecting, reviewing and/or updating information regarding a property. As discussed elsewhere herein, the mobile phone 402 includes a control button 404, a camera 406 and a display 408 in this embodiment. The controls, components and outputs of the mobile phone 402 may vary and remain within the scope and spirit of the present disclosure.

In the illustrative embodiment shown, the screen provides one or more specific maintenance actions associated with maintenance category. In some embodiments, the application may have one or more additional screens related to alternative categories associated with property maintenance. In some embodiments, this screen may be accessed through selection of the winterize button 412 shown in FIG. 10. This screen may also be accessed through other system operations.

In this embodiment, the display 408 shows an information box 452 near the top. The location of the information box 452 on the display may vary and remain within the scope and spirit of the present disclosure. In this embodiment, the information box 452 identifies winterizing as the relevant maintenance category. The information box 452 may identify any number of potential categories including locations on the property, property systems, and/or other property maintenance categories to which the screen applies and remain within the scope and spirit of the present disclosure. In some embodiments, the information box 452 may indicate a status level associated with each entry provided in the screen.

In some embodiments, the screens may include features to navigate more reminders than those able to be shown on one screen. For example, an application may include a scroll feature, a pagination feature allowing multiple pages with a limited number of reminders to be viewed page by page or other features to allow additional entries.

In this embodiment, the display also shows reminder boxes 454, 456, 458 and 460 which provide information regarding repair and/or maintenance activities associated with the category defined in the information box 452. In the embodiment shown, the reminders relate to specific maintenance items applicable to preparing the property for winter and include a wrap exterior faucets reminder 454, a check seals reminder 456, a maintain heater reminder 458 and a check carbon monoxide (CO) alarm reminder 460. The reminders shown in this embodiment are for illustrative purposes only and may vary in other screens or embodiments. In some embodiments, each reminder may be color or design coded to indicate additional information regarding the reminder. In some embodiments, each color may indicate an importance level associated with the reminders 454 through 460. For example, the check seals reminder 456 may include a yellow background to indicate a standard warning reminder, while the wrap exterior faucets reminder 454 may include a red background indicating a higher urgency than the check seals reminder 456.

In some embodiments, one or more of the reminders 454 through 460 may also operate as touch screen buttons. In some embodiments, alternative touch screen controls may be used, such as switches and other touch screen controls. When selecting one of the reminders 454 through 460, the application may open one or more windows or screens associated with the selected reminder. In some embodiments, the windows or screens may provide a summary status associated with the reminder. For example, one screen may indicate that a vendor has been scheduled to address the reminder.

In some embodiments, the reminders 454 through 460 may be operable to provide additional information regarding the maintenance item including the length of time in which the reminder has been active, the risk or benefit associated with the reminder, instructive information associated with the maintenance item, the basis for the reminder—such as a periodic time-based reminder, a prior inspection report, a user entry and/or other basis for the reminder—and/or other information regarding the maintenance item. For example, selecting the check carbon monoxide (CO) alarm reminder 460 may provide information regarding the standard timeframe for checking the alarm, risks caused by the failure to check a CO alarm, instructions for properly testing the alarm and contact information to identify a vendor associated with offering carbon monoxide alarms and/or testing services. In some embodiments, the reminder may also provide one or more links to additional information. For example, pressing the maintain heater reminder 458 may open a window providing a variety of links related to the reminder such as a link to vendors selling heater maintenance supplies, a link to a heating and air conditioning company's website, a do-it-yourself website and/or other relevant links.

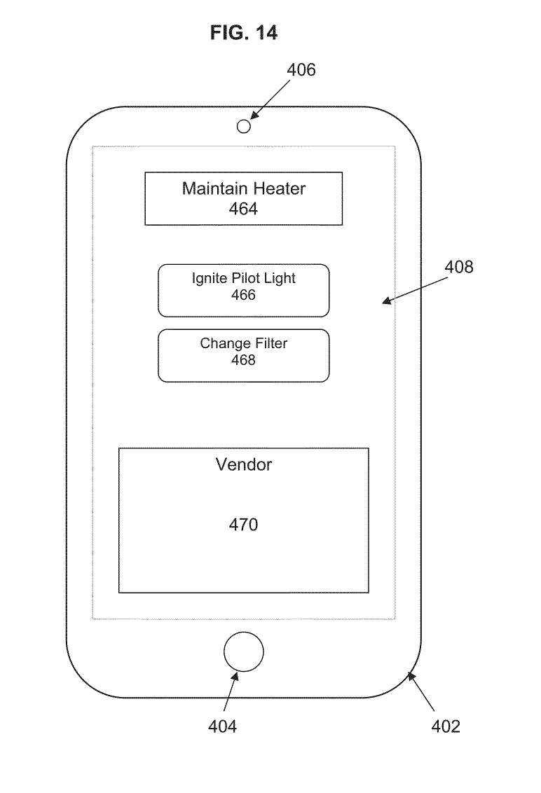

FIG. 14 depicts the mobile phone 402 showing another screen associated with an embodiment of software for collecting, reviewing and/or updating information regarding a property. As discussed elsewhere herein, the mobile phone 402 includes a control button 404, a camera 406 and a display 408 in this embodiment. The controls, components and outputs of the mobile phone 402 may vary and remain within the scope and spirit of the present disclosure.

In the illustrative embodiment shown, the screen provides more detailed information regarding a maintenance reminder. In some embodiments, the application may have one or more additional screens related to alternative maintenance reminders. In some embodiments, this screen may be accessed through selection of the maintain heater reminder 458 shown in FIG. 13. This screen may also be accessed through other system operations.

In this embodiment, the display 408 shows an information box 464 near the top. The location of the information box 464 on the display may vary and remain within the scope and spirit of the present disclosure. In this embodiment, the information box 464 identifies maintaining the heater as the relevant maintenance reminder category. The information box 464 may identify any number of potential categories to which the screen applies and remain within the scope and spirit of the present disclosure. In some embodiments, the information box 464 may indicate a status level associated with each entry provided in the screen.

In some embodiments, the screens may include features to navigate more reminders than those able to be shown on one screen. For example, an application may include a scroll feature, a pagination feature allowing multiple pages with a limited number of reminders to be viewed page by page or other features to allow additional entries.

In this embodiment, the display also shows maintenance information boxes 466 and 468 which provide information regarding more detailed repair and/or maintenance activities associated with the maintenance reminder category defined in the information box 464. In the embodiment shown, the reminders relate to specific actions applicable to maintaining the heater and include an ignite pilot light reminder 466 and a change filter reminder 468. The reminders shown in this embodiment are for illustrative purposes only and may vary in other screens or embodiments. In some embodiments, each reminder may be color or design coded to indicate additional information regarding the reminder. In some embodiments, each color may indicate an importance level associated with the reminders 466 and 468. For example, the change filter reminder 468 may include an orange background to indicate a standard warning reminder, while the ignite pilot light reminder 468 may include a blue background indicating a necessary action for further operation.

In some embodiments, one or more of the reminders 466 and 468 may also operate as touch screen buttons. In some embodiments, alternative touch screen controls may be used, such as switches and other touch screen controls. When selecting one of the reminders 466 and 468, the application may open one or more windows or screens associated with the selected reminder. In some embodiments, the windows or screens may provide a summary status associated with the reminder. For example, one screen may indicate that new filters have been ordered to address the reminder.

In some embodiments, the reminders 466 and 468 may be operable to provide additional information regarding the maintenance item including the length of time in which the reminder has been active, the risk or benefit associated with the reminder, instructive information associated with the maintenance item, the basis for the reminder—such as a periodic time-based reminder, a prior inspection report, a user entry and/or other basis for the reminder—and/or other information regarding the maintenance item. For example, selecting the ignite pilot light reminder 466 may provide information regarding the standard time of the year to ignite the pilot light, instructions for properly lighting the pilot light and contact information to identify a vendor associated with pilot light products and/or services. In some embodiments, the reminder may also provide one or more links to additional information. For example, pressing the change filter reminder 468 may open a window providing a variety of links related to the reminder such as a link to vendors selling filters, a link to a heating and air conditioning company's website, a do-it-yourself website and/or other relevant links.

In this embodiment, the screen includes a secondary information box 470 which may be used to provide advertising and/or other information regarding the maintenance items. For example, the secondary information box 470 may provide sponsored advertising from a vendor relating to the maintenance reminder shown in information box 464 and/or the reminders 466 and 468. The information box 470 may display graphics, text, video and/or other visual information. In some embodiments, a speaker associated with the mobile phone 402 may provide an audio portion associated with the information provided in the secondary information box 470. In some embodiments, the secondary information box 470 and/or portions thereof may be operable to request further information, initiate contact with a vendor or other third party associated with the information, change the information shown in the information box 470 and/or access additional information, such as a vendor's website providing more detailed information of product or service offerings regarding the maintenance reminder.

In some embodiments, the secondary information box 470 may provide a venue to facilitate the sale of goods by the system management company. For example, the secondary information box 470 may show three different types of air filters associated with different vendors which may be purchased through the system. Upon selection of one air filter option by the user, the system will facilitate the order processing through a select vendor associated with the selected air filter. The system may then update the status associated with the relevant reminder. For example, the status of the change filter reminder 468 may indicate that new filters have been ordered and provide tracking details related to the anticipated delivery of the filters.

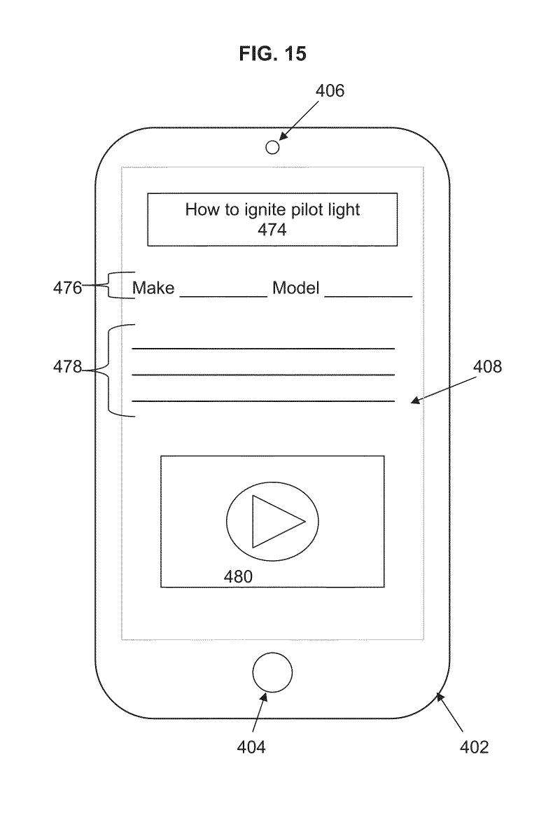

FIG. 15 depicts the mobile phone 402 showing another screen associated with an embodiment of software for collecting, reviewing and/or updating information regarding a property. As discussed elsewhere herein, the mobile phone 402 includes a control button 404, a camera 406 and a display 408 in this embodiment. The controls, components and outputs of the mobile phone 402 may vary and remain within the scope and spirit of the present disclosure.

In the illustrative embodiment shown, the screen provides information regarding the relevant appliance, system or other property feature and instructional information regarding a selected maintenance reminder. In some embodiments, the application may have one or more additional instructional screens related to alternative maintenance reminders. In some embodiments, this screen may be accessed through selection of the ignite pilot light reminder 466 shown in FIG. 14. This screen may also be accessed through other system operations.

In this embodiment, the display 408 shows an information box 474 near the top. The location of the information box 474 on the display may vary and remain within the scope and spirit of the present disclosure. In this embodiment, the information box 474 identifies the instructional category as “how to ignite pilot light.” The information box 474 may identify any number of potential instructional categories to which the screen applies and remain within the scope and spirit of the present disclosure. In some embodiments, the information box 474 may indicate a status level associated with instructional information. For example, the information box 474 may indicate that the instructions for igniting a pilot light are suitable for a novice practicing due care. In some embodiments, the information box 474 may indicate that the instructions are for a person who is experienced and not recommended for a novice.

In some embodiments, the screens may include features to navigate more reminders than those able to be shown on one screen. For example, an application may include a scroll feature, a pagination feature allowing multiple pages with a limited number of reminders to be viewed page by page or other features to allow additional entries.

In this embodiment, the display also shows feature information section 476, instruction section 478 and video section 480 which provide information regarding the selected feature and the instructional category shown in the information box 474. In some embodiments, the feature information section 476 provides information describing the specific property feature, such as the make and model of the heater for which the instructions shown on the screen are applicable. The feature information section may be populated based upon property information gathered previously for the system and/or may be input by a user. Such information may then be used by the system to populate sections 478 and 480 with proper instructions tailored to the specific feature on the property.

The instruction section 478 may provide text and/or graphic instructions for the steps of igniting the pilot light in this embodiment. For example, the instruction section 478 may show pictures of where the pilot light is located on the specific property feature and instruct the user to identify the pilot light location as the first step. In some embodiments, a new screen and/or window may be utilized for each step in the process. The instruction section 478 may also identify any tricks, warnings and/or other applicable information relating to the depicted step.

The video section 480 may provide video, animations and/or other graphic instructions for the steps of igniting the pilot light in this embodiment. For example, the video section 480 may show a video of someone lighting the pilot light on the specific property feature. In some embodiments, the video section 480 plays the visual portion of an audio-visual instructional. For example, the video section 480 may show an animated series of steps for lighting the pilot light while the audio portion providing audible instructions in sync with the animated steps is played by the speaker of the mobile phone 402. In some embodiments, a new screen and/or window may be utilized to show the instructional video. The video section 480 may also identify any tricks, warnings and/or other applicable information relating to the depicted step.

The sections shown in this embodiment are for illustrative purposes only and may vary in other screens or embodiments. In some embodiments, each section may be color or design coded to indicate additional information regarding the instructions.

In some embodiments, one or more of the sections 476 through 480 may also operate as touch screen buttons. In some embodiments, alternative touch screen controls may be used, such as switches and other touch screen controls. When selecting one of the sections 476 through 480, the application may open one or more windows or screens associated with the selected information or instruction.

In some embodiments, the sections 476 through 480 may be operable to provide additional information regarding the maintenance instructions including the length of time anticipated for completing the project, the risks associated with the project, related maintenance reminders associated with the property feature and/or other information.

In some embodiments, the system and/or application software may be accessible or operable based upon a payment system. For example, an inspector may be required to pay for each property entered into the system database. For another example, home owners may be required to pay a periodic service fee to access the database and receive the reminders from the database. In some embodiments, the payment system may be structured as a credit based system wherein a user may purchase a number of credits in advance or at the time of using the system.

In some embodiments of the systems and applications disclosed herein, the operations may be limited based upon an authorized access structure. For example, a home owner may be allowed to review data, receive reminders, order goods or services for their property, create customized alerts or reminders and/or manage the alerts or reminders. At the same time, a property inspector may be limited to inputting data associated with the property review and updating pre-existing data associated with the property, and a realtor may be limited to receiving reports associated with a given property. In addition, a system administrator may be able to manage account information, set up recall reminders associated with specific products and modify the structure or other aspects of the system. One skilled in the art will recognize that the authorized account options and structures may vary and remain within the scope and spirit of the present disclosure.

The invention being thus described and further described in the claims, it will be obvious that the same may be varied in many ways. Such variations are not to be regarded as a departure from the spirit and scope of the invention and all such modifications as would be obvious to one skilled in the art are intended to be included within the scope of the system, method and apparatuses described.

1. A networked system for management of a property using a property management file comprising:
a mobile data collection device comprising:
a user interface having a user input for receiving input from a user and a display for providing visual output to said user;
a network communication component for facilitating communication with a system network; and
a processor operatively associated with said user interface and said network communication component, wherein said processor is configured to facilitate collection of property data which comprises data associated with said property, display of said property data, and communication of said property data to the system network;
a networked server comprising:
a database configured to store property information, wherein said property information includes said property data and property feature data which comprises information regarding a plurality of potential property features;
a server network communication component configured to facilitate communication with said system network; and
a server processor configured to facilitate analysis of said property information, wherein said analysis comprises aggregating said property data into a property data file specific to said property, comparing said property data file with said property feature data to identify a set of property features applicable to said property from said plurality of potential property features, producing a property feature file based upon said comparison, wherein said property feature file comprises said property data correlated with said property feature data for said set of property features applicable to said property, and converting said property feature file into said property management file.

2. The system of claim 1 wherein said mobile data collection device is at least one of a smart phone, a tablet, a computer and a camera.

3. The system of claim 1 wherein said property feature data comprises at least one of a maintenance recommendation, instructional information and a product manual.

4. The system of claim 1 wherein said networked server comprises a database of property maintenance information.

5. The system of claim 4 wherein said property maintenance information comprises at least one of a maintenance instruction set, a maintenance calendar, a product supply list, and a vendor list.

6. The system of claim 1 wherein said networked server comprises a database of maintenance history records associated with a property.

7. A method for management of a property comprising the steps of:
a. collecting property information associated with said property via a mobile data collection device, wherein said mobile data collection device comprises a user interface and a data storage component, wherein said collecting property information comprises:
i. receiving inputs identifying a property identification associated with said property via said user interface,
ii. storing said property identification associated with said property within said data storage component,
iii. receiving inputs identifying a plurality of property features associated with said property via said user interface, and
iv. storing said plurality of property features associated with said property within said data storage component;
b. associating at least one property management recommendation from a database of property management recommendations with at least one of said plurality of property features associated with said property; and
c. providing an output comprising said at least one property management recommendation to a person associated with said property.

8. The method of claim 7 wherein the step of collecting property information further comprises:
i. receiving inputs identifying a status associated with each of said plurality of property features via said user interface, and
ii. storing said status associated with each of said plurality of property features within said data storage component.

9. The method of claim 8 wherein said at least one property management recommendation is based upon said status associated with each of said plurality of property features.

10. The method of claim 7 wherein the step of receiving inputs identifying said plurality of property features associated with said property occurs during a review of said property.

11. The method of claim 10 wherein said review of said property comprises a property inspection and said step of collecting property information based upon inputs to said user interface by an inspector.

12. The method of claim 11 wherein said output comprises an electronic inspection report.

13. The method of claim 7 further comprising the steps of providing periodic reminders including said property management recommendations.

14. The method of claim 7 further comprising the step of communicating said property information with a remote server, wherein said step of associating at least one property management recommendation with at least one of said plurality of property features associated with said property occurs within said remote server.

15. The method of claim 14 further comprising the step of communicating said at least one property management recommendation to a property management device, wherein said property management device facilitates communication with said person associated with said property.

16. A tangible, non-transitory computer readable storage medium storing computer executable program code that, when executed by a processor, causes performance of a method comprising:
a. collecting property information associated with said property, wherein said collecting property information comprises:
i. receiving inputs identifying a property identification associated with said property via a user interface,
ii. storing said property identification associated with said property within a data storage component,
iii. receiving inputs identifying a plurality of property features associated with said property via said user interface, and
iv. storing said plurality of property features associated with said property within said data storage component;
b. associating a property management recommendation from a database of property management recommendations with at least one of said plurality of property features associated with said property; and
c. providing an output comprising said property management recommendation to a person associated with said property.

17. The computer readable storage medium of claim 16 wherein associating said property management recommendation with at least one of said plurality of property features comprises the steps of:
a. determining whether a property feature is identified within said database of property management recommendations, and
b. identifying said property management recommendation which corresponds with said property feature that is identified within said database of property management recommendations.

18. The computer readable storage medium of claim 17 wherein associating said property management recommendation with at least one of said plurality of property features further comprises the steps of:
a. determining whether a property feature is associated with a status, and
b. identifying a preferred property management recommendation based upon said status.
